(19) United States
(12) Patent Application Publication
(10) Pub. No.: US 2020/0202178 A1
(43) Pub. Date: Jun. 25, 2020

(54) AUTOMATIC VISUAL DATA GENERATION FOR OBJECT TRAINING AND EVALUATION

(71) Applicant: ABB Schweiz AG, Baden (CH)

(72) Inventors: Remus Boca, Simsbury, CT (US); Zhou Teng, Hartford, CT (US); Thomas Fuhlbrigge, Ellington, CT (US); Magnus Wahlstrom, Vasteras (SE); Johnny Holmberg, Hallstahammer (SE)

(21) Appl. No.: 16/720,610

(22) Filed: Dec. 19, 2019

Related U.S. Application Data
(60) Provisional application No. 62/781,777, filed on Dec. 19, 2018.

(51) Int. Cl. G06K 9/62; G06N 3/08; B25J 9/16

(52) U.S. Cl. CPC G06K 9/6259; G06K 9/6262; G06K 2209/19; B25J 9/163; B25J 9/1697; G06N 3/08

(57) ABSTRACT

A robotic system is provided to automatically generate and evaluate visual data used for training neural networks. The robotic system includes a first robotic cell for generating a first visual data set and a second robotic cell for generating a second visual data set for comparison to the first visual data set.

### CROSS-REFERENCE TO RELATED APPLICATION

The present application claims the benefit of the filing date of U.S. Provisional Application Ser. No. 62/781,777 filed on Dec. 19, 2018, which is incorporated herein by reference.

### TECHNICAL FIELD

The present application generally relates to robotic cells and neural networks, and more particularly, but not exclusively, robotic cells to automatically generate and evaluate visual data used for training neural networks.

### BACKGROUND

The use of neural networks for state of the art perception tasks for robots is becoming critical to many industries. However, the enormity of the tasks of generating and labeling the visual data sets used for training neural networks hinders their application.

The visual data sets used for training should cover all the variations expected to be observed in images at runtime, such as lighting, scale, viewpoint, obstruction, etc. Generating a visual data set for training neural networks is an intense, time consuming, and labor intensive task that is currently manually performed. The size of the visual data set for one object can be in the range of millions of visual data points.

Labeling of the generated visual data set can include adding addition information to an image. Information that is added can include, for example, type of object, boundary of an object, position of the object in the image, etc. Because it is a manual task, the quality of the labeling needs to be thoroughly verified, which is another expensive and time-consuming task.

A subset of the visual data set is used for evaluation and accuracy of a trained neural network. The evaluation is used to test the performance of the trained neural network model. The evaluation is limited to the size of the evaluation visual data set, which is a subset of a visual training set. In order to completely evaluate a trained neural network model, a complete and different visual data set needs to be generated and labeled, further increasing the complexity, time and cost of the task.

Industrial applications require a level of robustness and accuracy that is difficult to achieve with manual generation, labeling, and evaluation of visual data sets and trained neural network models. Some existing systems have various shortcomings relative to certain applications. Accordingly, there remains a need for further contributions in this area of technology.

### SUMMARY

A robotic system is provided to automatically generate and evaluate visual data used for training neural networks. Artificial neural networks can be trained using a large set of labeled images. The visual data set, instead of the algorithms, can add major value to products and services. The proposed robotic system includes robotic cells to handle the sensors and/or the part or parts to be manipulated by the robot, and to control the environmental lights to create the variation needed for generating the visual data set. The robotic cells can also be installed in production to enhance and augment the existing learning models and algorithms and to provide a quick and automatic way to generate visual data sets for new or upgraded parts.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE FIGURES

The features, aspects, and advantages of the present disclosure will become better understood with regard to the following description, appended claims, and accompanying drawings where:

FIG. 1 is a schematic illustration of a robotic cell system for training and evaluation according to one exemplary embodiment of the present disclosure; and

FIG. 2 is a flow diagram of a procedure for training and evaluation of a neural network model with a robotic cell system.

### DETAILED DESCRIPTION OF THE ILLUSTRATIVE EMBODIMENTS

For the purposes of promoting an understanding of the principles of the application, reference will now be made to the embodiments illustrated in the drawings and specific language will be used to describe the same. It will nevertheless be understood that no limitation of the scope of the application is thereby intended. Any alterations and further modifications in the described embodiments, and any further applications of the principles of the application as described herein are contemplated as would normally occur to one skilled in the art to which the application relates.

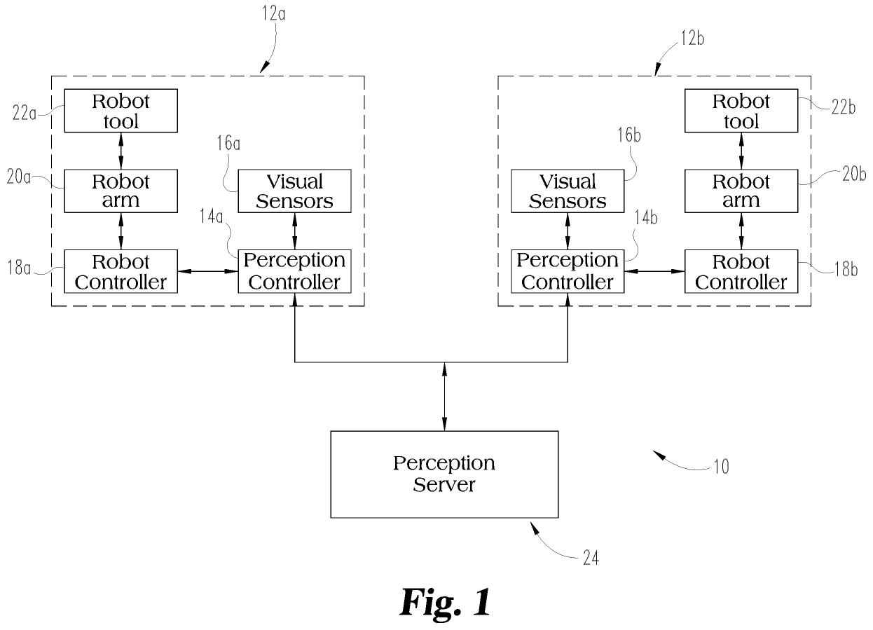

Referring to FIG. 1, an illustrative robotic cell system 10 is shown schematically. It should be understood that the robot system 10 shown herein is exemplary in nature and that variations in the robot system is contemplated herein. The robot system 10 can include a first robotic cell 12a for training and a second robotic cell 12b for evaluation. Each robotic cells 12a, 12b includes a perception controller 14a, 14b, respectively. Each perception controller 14a, 14b communicates with one or more visual sensors 16a, 16b and a robot controller 18a, 18b, respectively. Visual sensors 16a, 16b can include, for example, one or more cameras or other suitable device to capture images and other data. Each robot controller 18a, 18b can control one or more of the corresponding robot arms 20a, 20b, each of which is operable to manipulate one or more corresponding robot tools 22a, 22b attached thereto.

Each of the perception controllers 14a, 14b is further operably connected to a perception server 24. Perception server 24 and/or perception controllers 14a, 14b can include a CPU, a memory, and input/output systems that are operably coupled to the robotic cell 12a, 12b. The perception server 24 and/or perception controllers 14a, 14b are operable for receiving and analyzing images captured by the visual sensors 16a, 16b and other sensor data used for operation of the robotic cells 12a, 12b. In some forms, the perception server 24 and/or perception controllers 14a, 14b are defined within a portion of one or more of the robotic cells.

The robotic cells 12a, 12b are operable to perform several functions. For example, the robotic cells 12a, 12b can be operable to handle sensors and/or parts. For example, the robotic cells 12a, 12b can handle the part and/or a sensor to create a variation in the relative position between them. One or more sensors can be used at the same time to collect visual data at the perception controller 14a, 14b using visual sensors 16a, 16b.

The robotic cells 12a, 12b are also operable to control environmental illumination. The variation of the illumination is control by the robot script or programs in robot controllers 18a, 18b and/or perception controllers 14a, 14b. This variation can be performed in different ways, such as by running the entire motion script once with one illumination level, or by varying the illumination in each robot position at the robot stop at certain set points.

Robot scripts can also be ran to scan and collect visual data before and after one or more parts or objects are placed in front of the robotic cells 12a, 12b. In order to reduce the robot operator input (and not to replace the generation, labeling and evaluation manual tasks with robot programming) the robot programs for moving the robot tool 22a, 22b and data collection are generated automatically based on the input parameters. The script are designed and ran for a scene without a part and for the scene with a part. Collecting the data can be specified at discrete locations or continuously collected.

The robotic cells 12a, 12b are operable for processing and labeling visual data. The robotic cells 12a, 12b are controlled so that the steps and environment enable labeling automatically. For example, for an object and boundary box detection, the boundary boxes can be automatically determined by the difference between the visual data with a part and without a part.

The robotic cell 12b and perception server 24 are operable to compare functions of labeled visual data from robotic cell 12a and new visual data for evaluation. Evaluation of a trained neural network is critical to assess the performance of a neural network. The evaluation is automatically performed since the robotic cell 12b knows the location of the part relative to the sensors. By comparing this data to the results returned by inferring from the neural network, the robot system 10 can calculate the efficiency of a perception algorithm.

The evaluation is typically more complex than the generation of the visual data set that is used for training, as the evolution in the data set should match the use at the production/use time. For example: 1) multiple parts can be sensed at one time with multiple backgrounds; or 2) parts can be sensed that are placed in different locations within the robot workspace; or 3) parts are occluded; and 4) other situations. For this reason, an efficient solution can be to have at least two robotic cells, one for training/generation and one for evaluation, as shown in FIG. 1.

System 10 provides an improvement in the speed of 1) the generation and labeling of visual data sets; and 2) the quality and accuracy of a trained neural network model. System 10 provides specialized robotic cells 12a, 12b that can work in parallel to automatically generate, evaluate and label visual data sets and train neural network models.

These specialized robotic cells 12a, 12b 1) handle sensors and/or parts; 2) control environmental illumination; 3) run robot scripts to scan and collect visual data before and after one or more parts are placed in front of them; 4) process the collected visual data to label the visual data; and 5) compare functions of labeled and new visual data for evaluation. In one embodiment, the robotic cells receive as inputs 1) one or more parts and their associated grippers; 2) parameters and their ranges; and 3) type of operations, such as generation or evaluation of visual data sets.

The systems and methods herein include robotic cells 12a, 12b that are controlled to generate visual data sets and to evaluate a trained neural network model. In parallel, the robotic cells 12a, 12b automatically generate a visual data set for training and evaluation of neural networks, automatically label a visual data set for each robotic cell, estimate the performance of the trained neural network with evaluation parameters outside the parameters of the generating the visual data set for training the neural network, and complete generation of a visual data set by controlling all the parameters (during the generation of the visual data set) affecting the performance of a neural network. The perception server 24 can also speed up the generation of visual data set by scaling the generation across multiple specialized robot cells.

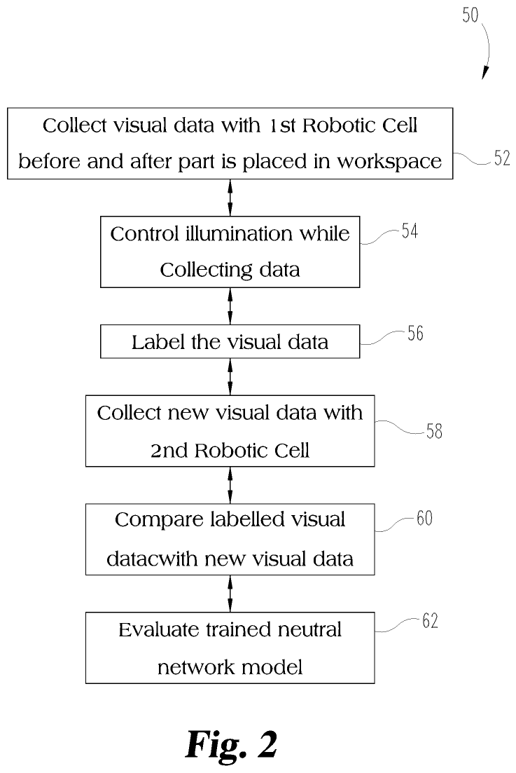

One embodiment of a procedure to evaluate a trained neural network model is shown in FIG. 2. Procedure 50 includes an operation 52 to collect visual data with the first robotic cell before and after a part is placed in the workspace. Procedure 50 includes an operation 54 to control illumination of the workspace while collecting the visual data in operation 52. Procedure 50 includes an operation 56 to label the visual data collected in operation 52.

Procedure 50 continues at operation 58 to collect new visual data with the second robotic cell. This can be performed in parallel with operation 52, or serially. At operation 60 the labelled visual data collected with the first robotic cell is compared with the new visual data collected with the second robotic cell. Procedure 50 continues at operation 62 to evaluate the trained neural network model in response to the comparison. The neural network model can be updated based on the comparison to improve performance.

Various aspects of the present disclosure are contemplated. For example, a system includes a first robotic cell within a neural network and a second robotic cell with the neural network. The first robotic cell includes at least one visual sensor and at least one robotic arm for manipulating a part or a tool, and is operable to generate and label a visual data set. The second robotic cell includes at least one visual sensor and at least one robotic arm for manipulating a part or a tool, and is operable to compare the labeled visual data with new visual data to evaluate the new visual data based on the labeled visual data set.

In one embodiment, the first robotic cell and the second robotic cell each include respective ones of a first perception controller and a second perception for managing the visual data sets, and each of the first and second perception controllers is connected to a central perception server.

In one embodiment, each of the first and second perception controllers of the first and second robotic cells is in communication with the at least one visual sensor of the corresponding one of the first and second robotic cells.

In one embodiment, the first robotic cell and the second robotic cell include respective ones of a first robot controller and a second robot controller, and each of the first and second robot controllers is operable to manipulate the at least one robotic arm of the corresponding one of the first robotic cell and the second robotic cell. In an embodiment, each of the robotic arms includes a tool attached thereto.

In an embodiment, each of the first and second robotic cells is operable to control illumination of a workspace in which the part or the tool is placed. In one embodiment, the labeled visual data set is generated without the part or the tool in the workspace and with the part or the tool in the workspace. In one embodiment, the new visual data set is generated without the part of the tool in the workspace and with the part or the tool in the workspace.

In one embodiment, the first robotic cell and the second robotic cell operate in parallel to automatically generate the visual data set and the new visual data. In one embodiment, the labeled visual data set and the new visual data each include a determination of a location of the part or the tool relative to the at least one visual sensor of the first and second robotic cells, respectively.

In another aspect, a method includes operating a first robotic cell to collect visual data before and after a part is placed in a workspace of the first robotic cell; controlling an illumination of the workspace while collecting the visual data; labeling the visual data; operating a second robotic cell to collect new visual data; and comparing the labeled visual data and the new visual data to evaluate a trained neural network model.

In one embodiment, the second robotic controller is operated before and after the part is placed in the workspace to collect the new visual data. In one embodiment, the method includes controlling the illumination of the workspace with the second robotic cell while collecting the new visual data.

In one embodiment, the first robotic cell and the second robotic cell are operated in parallel to automatically generate the visual data and the new visual data. In one embodiment, the visual data and the new visual data include a location of the part relative to a first sensor of the first robotic cell and a location of the part relative to a second sensor of the second robotic cell, respectively.

In one embodiment, the method includes operating at least one of the first robotic cell and the second robotic cell to place the part in the workspace. In an embodiment, the method includes operating each of the first robotic cell and the second robotic cell to vary a relative position between the part in the workspace and a first sensor of the first robotic cell and a second sensor of the second robotic cell, respectively.

In one embodiment, the first robotic cell and the second robotic cell include respective ones of a first perception controller and a second perception controller, and each of the first and second perception controllers is connected to a central perception server.

In an embodiment, each of the first and second perception controllers is in communication with at least one visual sensor of the corresponding one of the first and second robotic cells.

In an embodiment, the first robotic cell and the second robotic cell include respective ones of a first robot controller and a second robot controller, and each of the first and second robot controllers is operable to manipulate a respective one of a first robotic arm and a second robotic arm of the corresponding one of the first robotic cell and the second robotic cell.

While the application has been illustrated and described in detail in the drawings and foregoing description, the same is to be considered as illustrative and not restrictive in character, it being understood that only the preferred embodiments have been shown and described and that all changes and modifications that come within the spirit of the applications are desired to be protected. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A system comprising:
a first robotic cell within a neural network, the first robotic cell including at least one visual sensor and at least one robotic arm for manipulating a part or a tool, the first robotic cell being operable to generate and label a visual data set; and
a second robotic cell within the neural network, the second robotic cell including at least one visual sensor and at least one robotic arm for manipulating the part or the tool, the second robotic cell being operable to compare the labeled visual data with new visual data to evaluate the new visual data based on the labeled visual data set.

2. The system of claim 1, wherein the first robotic cell and the second robotic cell include respective ones of a first perception controller and a second perception controller, and each of the first and second perception controllers is connected to a central perception server.

3. The system of claim 2, wherein each of the first and second perception controllers of the first and second robotic cells is in communication with the at least one visual sensor of the corresponding one of the first and second robotic cells.

4. The system of claim 3, wherein the first robotic cell and the second robotic cell include respective ones of a first robot controller and a second robot controller, and each of the first and second robot controllers is operable to manipulate the at least one robotic arm of the corresponding one of the first robotic cell and the second robotic cell.

5. The system of claim 4, wherein each of the robotic arms includes a tool attached thereto.

6. The system of claim 1, wherein each of the first and second robotic cells is operable to control illumination of a workspace in which the part or the tool is placed.

7. The system of claim 6, wherein the labeled visual data set is generated without the part or the tool in the workspace and with the part or the tool in the workspace.

8. The system of claim 7, wherein the new visual data set is generated without the part of the tool in the workspace and with the part or the tool in the workspace.

9. The system of claim 1, wherein the first robotic cell and the second robotic cell operate in parallel to automatically generate the visual data set and the new visual data.

10. The system of claim 1, wherein the labeled visual data set and the new visual data each include a determination of a location of the part or the tool relative to the at least one visual sensor of the first and second robotic cells, respectively.

11. A method, comprising:
operating a first robotic cell to collect visual data before and after a part is placed in a workspace of the first robotic cell;
controlling an illumination of the workspace while collecting the visual data;
labeling the visual data;
operating a second robotic cell to collect new visual data; and
comparing the labeled visual data and the new visual data to evaluate a trained neural network model.

12. The method of claim 11, wherein the second robotic controller is operated before and after the part is placed in the workspace to collect the new visual data.

13. The method of claim 11, further comprising controlling the illumination of the workspace with the second robotic cell while collecting the new visual data.

14. The method of claim 11, wherein the first robotic cell and the second robotic cell are operated in parallel to automatically generate the visual data and the new visual data.

15. The method of claim 11, wherein the visual data and the new visual data include a location of the part relative to a first sensor of the first robotic cell and a location of the part relative to a second sensor of the second robotic cell, respectively.

16. The method of claim 11, further comprising operating at least one of the first robotic cell and the second robotic cell to place the part in the workspace.

17. The method of claim 16, further comprising operating each of the first robotic cell and the second robotic cell to vary a relative position between the part in the workspace and a first sensor of the first robotic cell and a second sensor of the second robotic cell, respectively.

18. The method of claim 11, wherein the first robotic cell and the second robotic cell include respective ones of a first perception controller and a second perception controller, and each of the first and second perception controllers is connected to a central perception server.

19. The method of claim 18, wherein each of the first and second perception controllers is in communication with at least one visual sensor of the corresponding one of the first and second robotic cells.

20. The method of claim 19, wherein the first robotic cell and the second robotic cell include respective ones of a first robot controller and a second robot controller, and each of the first and second robot controllers is operable to manipulate a respective one of a first robotic arm and a second robotic arm of the corresponding one of the first robotic cell and the second robotic cell.
